(19) United States
(12) Patent Application Publication
(10) Pub. No.: US 2013/0281280 A1
(43) Pub. Date: Oct. 24, 2013

(54) Method of Extracting Oil from Thin-stillage

(71) Applicant: Sanjeev Agarwal, Boone, IA (US)

(72) Inventor: Sanjeev Agarwal, Boone, IA (US)

(73) Assignee: TECHNOCHEM INTERNATIONAL, INC., Boone, IA (US)

(21) Appl. No.: 13/540,843

(22) Filed: Jul. 3, 2012

Related U.S. Application Data
(60) Provisional application No. 61/507,477, filed on Jul. 13, 2011.

(51) Int. Cl. B01D 17/02

(52) U.S. Cl. CPC B01D 17/0217
USPC 494/37

(57) ABSTRACT

A method of removing oil from an emulsion by-product of alcohol production from grain. A concentration-style centrifuge is used to separate the emulsion by-product into a light phase containing the oil and a heavy phase containing free-water and solids. The pH of the light phase is raised to approximately neutral by the addition of an alkaline composition to break the emulsion. The broken light phase is heated to between 170-200° F. and the oil is separated from the broken light phase in a disk-type centrifuge.

This application claims priority to U.S. patent application Ser. No. 61/507,477, filed Jul. 13, 2011, which is incorporated herein by this reference in its entirety.

### BACKGROUND OF THE INVENTION

The present invention relates generally to the extraction of oil from a by-product of the production of ethanol from corn and, more specifically, to a simple and efficient method of extracting oil from the thin-stillage produced during the production of ethanol from corn. Thin-stillage is a byproduct of ethanol production process that is produced after extraction of ethanol and is variously called thin-stillage, stillage, or syrup. It contains water, fiber, corn oil, and miscellaneous other components. The thin-stillage is subject to evaporation to reduce the water content to about 60-80%. The rest constitutes fiber, oil, and miscellaneous other components. This invention is particularly suitable for thin-stillage available at temperatures under 150° F.

The amount of ethanol produced from corn has grown enormously in the past several years. Among the by-products produced is what is called thin-stillage. This by-product contains corn oil that is a valuable commodity that can add to the economy of ethanol production if it can be efficiently extracted from the thin-stillage. Extraction of oil from the thin-stillage is difficult, however, in at least that the valuable corn oil is present in the aqueous thin-stillage in an emulsified form. In addition, the thin-stillage is at an elevated temperature (between about 100° F. and 150° F.) and has acidic pH, typically about 3, due to the addition of sulfuric acid in the ethanol production process, these factors makes the thin-stillage corrosive, presenting a risk of damage to the extraction processing equipment. Moreover, it gets passed on to the oil which presents the risk of damage to the storage of oil and downstream processing equipment.

The traditional approach to free the oil from its emulsified state is to heat the emulsion. It is known in the art that heating the feed to 180-220° F. and keeping the feed at an elevated temperature for a certain period of time breaks the emulsion. Once the emulsion between the oil and water is broken, the oil is free to be separated. The separation can take place either by gravity settling or by a mechanical centrifuge.

There is nothing unique about the centrifuge compared to gravity settling except that it quickens the separation compared to gravity separation and the separation is more effective. Heat is also useful in centrifuge separation because it reduces the viscosity of oil and thus makes it easier to separate. This approach has been taken industry-wide by technology suppliers such as Greenshift, ICM, Westfalia, and others.

There are several limitations of the process described in patented processes.

The amount of heat required to break the emulsion is very high. For example, if the emulsion breaks at 220° F. and the feed is available at 180° F., we need about 220 BTU/gallon of feed. The heat requirement increases to 606 BTU/gal if the feed is available at 150° F. and to 740 BTU/gal if the feed is available at 110° F. Some ethanol plants produce the feed at 150-180° F., which is not so bad but some plants produce the feed at 100-150° F. which then requires the addition of a considerable amount of heat. In other words, it takes three times more energy to heat the feed if the feed is available at 110° F. as compared to 180° F. In currently available technologies, all separation takes place at 180-220° F. but typically at or near 220° F.

The art has considered other technologies that can reduce the amount of energy required for separation. The current technologies described above have had problems with breaking the emulsion completely with heat. Hence, the oil recovery is about 0.3 pounds per bushel of corn fed to the ethanol plant or about 35% of available oil in thin-stillage. Almost 65% is lost in the process because it is held up in emulsified form even after the heat treatment.

Some companies such as Nalco, GE, and Ashland are selling proprietary de-emulsifying agents to break the emulsion between oil and water more effectively. They claim to have increased the oil recovery. However, the cost of such agents is approximately $2 per pound. At the quantities required of such agents to break the emulsion, such costs are prohibitive.

What is needed is a simple and efficient method that breaks the emulsion with less heat and better chemicals and enables higher oil recovery especially from thin-stillage produced at 110-150° F. range. Moreover, solve the problem of acid content in the thin-stillage so the oil produced does not carry any acid.

### SUMMARY OF THE INVENTION

The present invention includes method of removing oil from an emulsion by-product of alcohol production from grain. A light phase of the emulsion by-product containing the oil and emulsion is separated from a heavy phase containing free-water and solids in a centrifuge. The pH of the light phase is raised by the addition of an alkaline composition to break the emulsion and remove corrosivity from the extracted oil. The broken light phase is heated to between about 170-200° F. The oil is separated from the broken light phase in a centrifuge.

Novel aspects of the present inventive process include:

The first centrifuge separates the oil and emulsion rather than just the oil. This more effectively breaks the emulsion to separate the oil enabling the recovery of almost twice the amount of oil.

The traditional process uses heat and residence time to break the emulsion. In the present process, the emulsion is broken with the addition of an alkaline composition, such as caustic soda, and some heat. The second centrifuge separates the oil from the water.

The present process uses less energy (only about 3-20%) as compared to known processes.

The present process results in a pH-neutral oil that does not pose risk of corrosion to storage tanks and other downstream processing equipment.

Moreover, because of the use of second centrifuge to separate the oil, the oil comes out much cleaner (fewer solids) and thus does not require further decanting to clean it.

Both centrifuges are disk stack centrifuges but designed differently. The first centrifuge is designed to remove large quantities of solids and water and the second centrifuge is designed to primarily remove small quantities of solids and water.

### BRIEF DESCRIPTION OF THE DRAWING

FIG. 1 is a schematic flow diagram of an embodiment of the present invention.

### DESCRIPTION OF THE INVENTION

The term “free oil” as used herein, refers to an oil that is not emulsified, physically or chemically bound or trapped by components in the process stream and can be phase separated from the process stream, i.e., recovered from the process stream via mechanical processing and/or non-mechanical processing.

The term “emulsion” as used herein refers to a mixture of two or more immiscible liquids, i.e., liquids which are sparingly soluble within each other.

An emulsion can contain entrapped components, such as oil, as well as other components, including, but not limited to, starches, free fatty acids, fatty acid esters, phospholipids, grain germ fractions, yeast, protein, fiber, glycerol, residual sugars, other organic compounds and/or other inorganic compounds.

The term “emulsion breaking” as used herein refers to a chemical treatment, i.e., chemical process, which causes destabilization of a stable emulsion, in which at least some of the stable emulsion is broken to produce a broken emulsion, thus releasing entrapped oil. As such, the term “emulsion breaking” is intended to include any type of stable emulsion “reduction” in which at least a portion of emulsified oil in the stable emulsion concentrate is released from an emulsified state by other than gravitational means (phase separation).

The process or the present invention is carried out in a corn-oil extraction plant. The feed or starting material to the corn-oil extraction plant is thin-stillage, a by-product of the production of ethanol from corn. The composition of thin-stillage varies from plant to plant. This invention is particularly developed to address the challenges of recovering oil from thin-stillage that is available at lower temperatures (typically 110-150° F.) and lower pH (typically 3-4). The usual composition is set out in Table 1.

TABLE 1
Typical Composition of Thin-Stillage

| Component | Percentage present |
|---|---|
| Oil | 5% |
| Water | 72% |
| Solids | 23% |

The solids component is comprised primarily of protein and fiber.

### Example 1

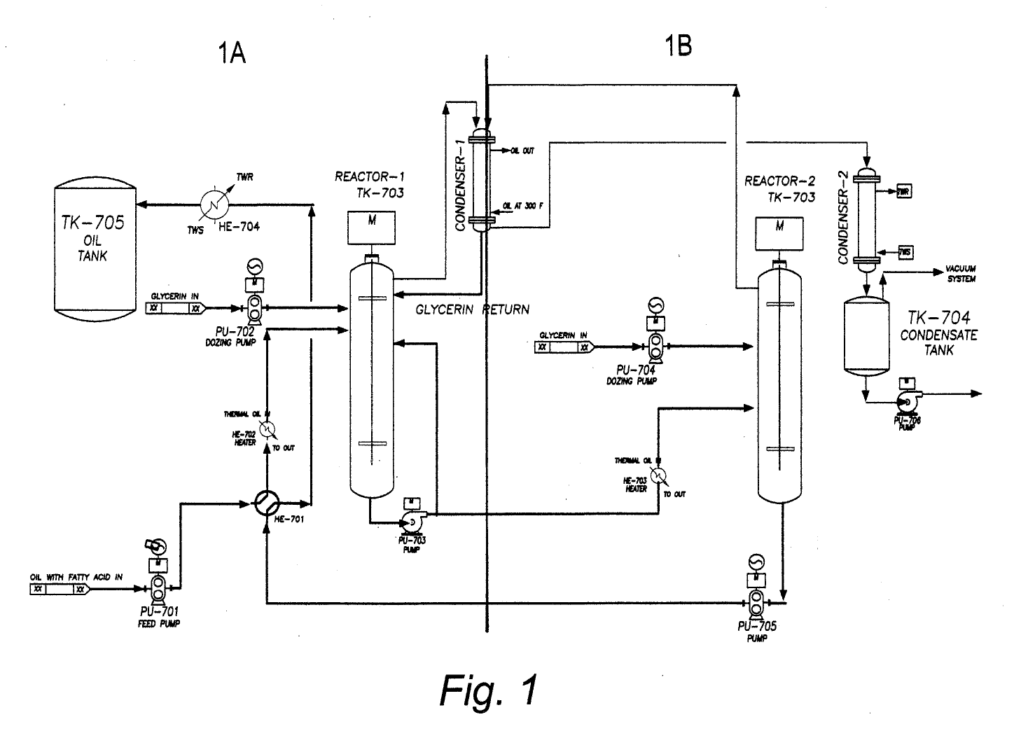

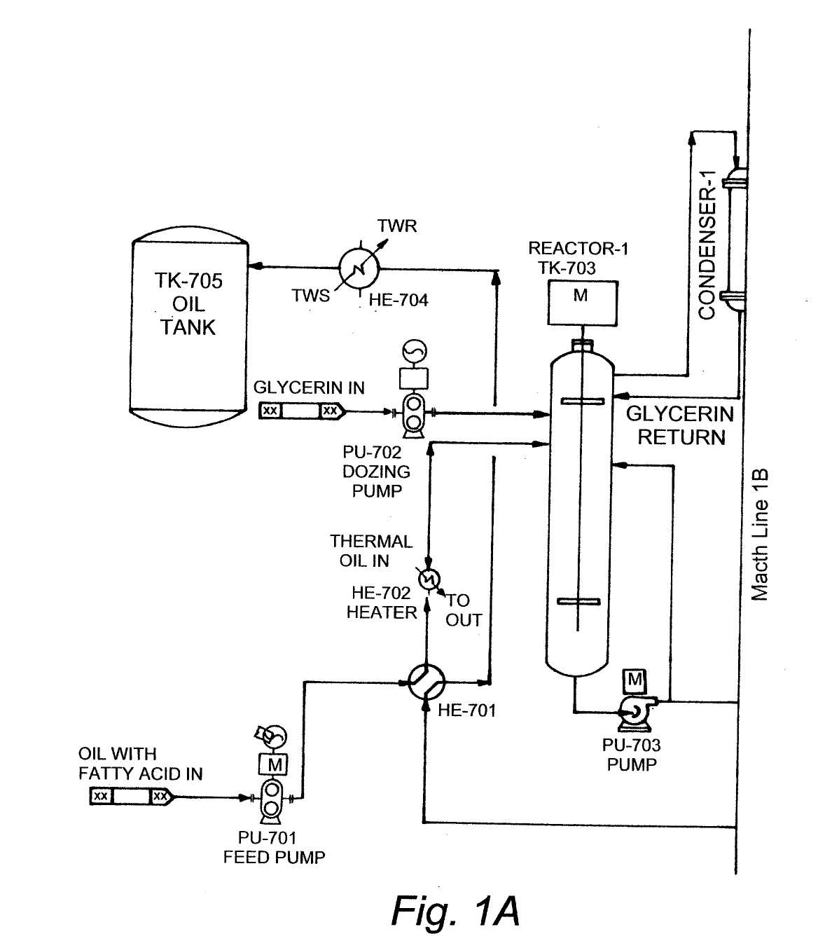

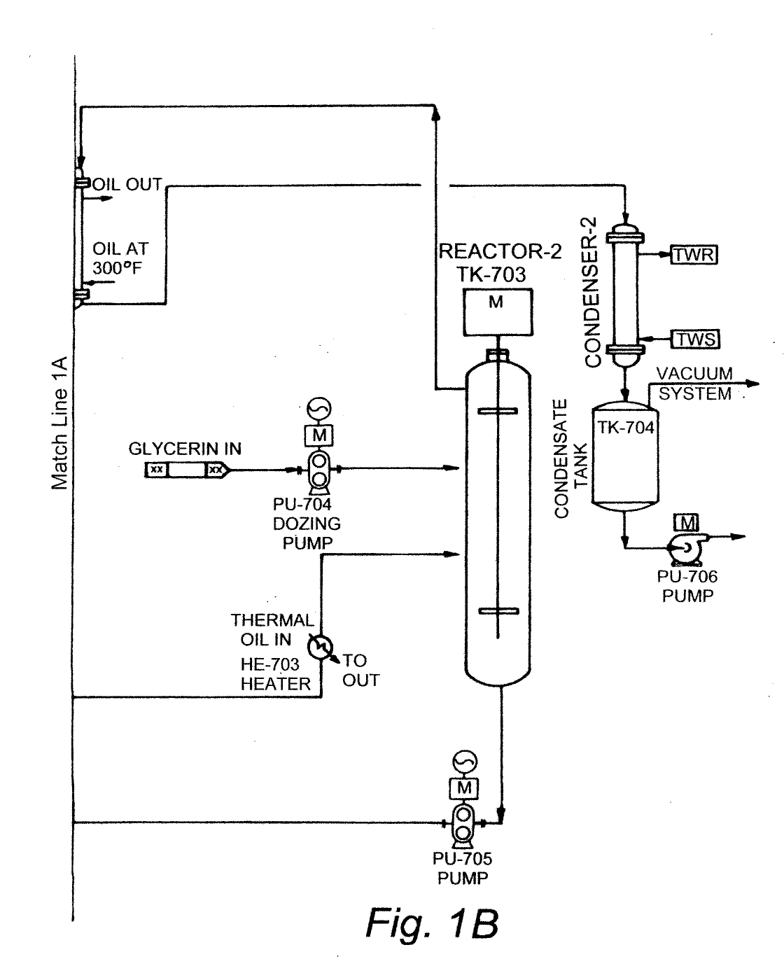

As illustrated in FIG. 1, the thin-stillage (feed) is received in tank 10 at the temperature at which the stillage is received from evaporators (usually between 110-180° F.). While the Greenshift process teaches that the temperature of the stillage needs to be above 150° F., the present process is specially designed to work at temperatures below 150° F. In fact, the present process has been satisfactorily operated at as low as 110° F.

Pump 12 is used to pump the feed from tank 10 to centrifuge 14. Commercially available de-emulsifying agents (such as those made by Nalco, GE, Ashland and others) may be added in tank 10 to aid the process. Preferably, a disc-stack centrifuge 14 is used to separate the light phase containing the oil and emulsion from the heavy phase containing free-water and solids. Note that the purpose is to separate the oil and emulsion not just the oil. We accomplish this by adjusting the separation point based on the specific gravity of the light phase and the heavy phase. The light phase may be 3-20% of the feed. The exact amount is determined based on the amount of water, oil, and emulsion in the feed.

The heavy phase is discharged using pump 16.

The light phase is received in tank 18. The light phase (containing oil and emulsion) is treated with a alkaline chemical solution to break the emulsion. The light phase is heated to 170-200° F. in order to reduce the viscosity of oil so it can flow through a centrifuge easily. Because the amount of material (light phase) is 3-20% of the feed, the amount of heat required is 3-20% of the energy required in the Greenshift process. Moreover, since the preferred alkaline chemical used in the present process is commercially available caustic soda (NaOH, sold at 15 cents/pound), the cost of treating the light phase is minimal. Because the alkaline chemical is added in the light phase, which is 3-20% of the feed, the amount of chemical required is also 3-20% of the chemicals required in other processes. Enough alkaline chemical is added to reach a pH of approximately 7.

The treated stream is pumped with pump 18 to a second centrifuge 20 to separate the oil from water. This is the water that is freed from the emulsion of oil and water. All other components in the feed (such as free water and solids) have already been removed in the first centrifuge 14. The centrifuge 20 is preferably a disc-stack centrifuge designed specifically to separate clean oil from water.

The oil is received in storage tank 22. The oil recovery in the present process is upwards of 65% as compared to 35% in available processes.

Note also that in the present process, the oil is free of sulfuric acid. This means that the downstream processors do not have to worry about corrosion. The oil can be stored in carbon steel tanks and does not require special transportation.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

What is claimed is:

1. A method of removing oil from an emulsion by-product of alcohol production from grain, comprising the steps of:
(a) separating in a centrifuge a light phase of the emulsion by-product containing the oil and emulsion from a heavy phase containing free-water and solids;
(b) raising the pH of the light phase by the addition of an alkaline composition to break the emulsion and remove corrosivity from the extracted oil;
(c) heating the broken light phase to between 170-200° F.; and
(d) separating in a centrifuge the oil from the broken light phase.

2. A method of claim 1, wherein the alkaline composition is selected from the group consisting of salts of alkali metals and alkali earth metals.

3. A method of claim 2, wherein the salts are selected from the group consisting of NaOH and KOH.
